(19) United States
(12) Patent Application Publication
(10) Pub. No.: US 2025/0175872 A1
(43) Pub. Date: May 29, 2025

(54) METHOD AND APPARATUS FOR CELL SWITCHING

(71) Applicant: FUJITSU LIMITED, Kawasaki-shi (JP)

(72) Inventors: Meiyi JIA, Beijing (CN); Su YI, Beijing (CN); Yang LU, Beijing (CN)

(73) Assignee: FUJITSU LIMITED, Kawasaki-shi (JP)

(21) Appl. No.: 19/038,789

(22) Filed: Jan. 28, 2025

Related U.S. Application Data
(63) Continuation of application No. PCT/CN2022/110980, filed on Aug. 8, 2022.

(51) Int. Cl. H04W 36/08; H04L 1/1812; H04W 12/106; H04W 36/24; H04W 76/19; H04W 76/20; H04W 80/02

(52) U.S. Cl. CPC H04W 36/08; H04L 1/1812; H04W 12/106; H04W 36/249; H04W 76/19; H04W 76/20; H04W 80/02

(57) ABSTRACT

An apparatus for cell switching, applicable to a terminal equipment, includes: a first receiver configured to receive a MAC CE (Control Element) from a first network node; and a processor circuitry configured to switch a serving cell to a cell indicated by the MAC CE, wherein the switching a serving cell to a cell indicated by the MAC CE comprises at least one of a L1 reset procedure, a L2 reset procedure, or processing a timer maintained by an RRC (Radio Resource Control) layer.

### CROSS-REFERENCE TO RELATED APPLICATION

This application is a continuation application of International Application PCT/CN2022/110980 filed on Aug. 8, 2022, and designated the U.S., the entire contents of which are incorporated herein by reference.

### TECHNICAL FIELD

This disclosure relates to the field of communication technologies.

### BACKGROUND

Network controlled mobility is applicable to terminals in a connected state and may be divided into two types: cell-level mobility and beam-level mobility.

The cell-level mobility requires explicit RRC signaling to be triggered, i.e. handover. The handover mechanism triggered by RRC requires a terminal (UE) to at least reset an MAC entity and re-establish RLC. RRC managed handovers without and without packet data convergence protocol (PDCP) entity re-establishment are both supported. For data radio bearers (DRBs) using an RLC AM mode, the PDCP may either be re-established together with a secure key change or initiate a data recovery procedure without a key change. For DRBs using an RLC UM mode, the PDCP can either be re-established together with a security key change or remain as it is without a key change. For signaling radio bearers (SRBs), the PDCP may either remain as it is, discard its stored PDCP PDUs/SDUs without a key change, or be re-established together with a security key change.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

When a terminal moves from a coverage area of a cell to a coverage area of another cell, a serving cell change (switch) needs to be performed at a certain point. Currently, the change of the serving cell is triggered by L3 measurement and completed by RRC signaling, and reconfiguration with synchronization triggered for changing a primary cell (PCell) and a primary secondary cell (PSCell) and release of secondary cells (SCells) (if applicable) are increased.

Inter-cell mobility may include intra-gNB-DU mobility, inter-gNB-DU mobility within a gNB-CU, and inter-gNB-CU mobility.

It was found by the inventors that when a terminal moves from a coverage area of a cell to a coverage area of another cell, serving cell change needs to be performed at a certain point. Currently, in various scenarios, serving cell change is triggered by L3 measurement and completed by RRC signaling, involving complete L2 (and L1) resetting, thereby resulting in longer latency, higher signaling overhead, and longer interruption times than beam switching mobility.

Regarding complete L2 resetting:
regarding PDCP entity reestablishment:
when an upper layer requests PDCP reestablishment, a transmitting PDCP entity will:
   for UM DRBs and AM DRBs, if drb-ContinueROHC is not configured, an uplink ROHC protocol is reset, and starts with the IR state of U-mode defined in RFC 3095 and RFC 4815;
   for UM DRBs and AM DRBs, drb-ContinueEHC-UL is not configured, an uplink EHC protocol is reset;
   for AM DRBs, if drb-ContinueUDC is not configured, a UDC compression buffer is reset to be all zeros and a dictionary is pre-filled;
   for SRBs and UM DRBs, TX_CEXT is set to be a initial value;
   for SRBs, all stored PDCP SDUs and PDCP PDUs are discarded;
   during PDCP entity reestablishment, an encryption algorithm and key provided by the upper layer are applied;
   during PDCP entity reestablishment, an integrity algorithm and key provided by the upper layer are applied;
   for UM DRBs, for each PDCP SDU that has already been associated with a PDCP SN but a corresponding PDU has not yet been submitted to a lower layer, and for AM DRBs with PDCP entities suspended for a Uu interface, starting from a first PDCP SDU with a PDCP data PDU having not been confirmed to be successfully transmitted at the lower layer, for each PDCP SDU that has been associated with a PDCP SN, it is considered that the PDCP SDUs are received from the higher layer; and before PDCP reestablishment, discardTimer is not restarted, and transmission of PDCP SDUs is performed in an ascending order of COUNT values associated with the PDCP SDUs;
   for AM DRBs with PDCP entities that are not suspended, starting from a first PDCP SDU with a corresponding PDCP data PDU has not been confirmed to be successfully transmitted by the lower layer, before PDCP entity establishment, retransmission or transmission of all PDCP SDUs that have been associated with PDCP SNs are is performed in an ascending order of COUNT values associated with the PDCP SDUs, which are defined as follows:
      header compression of PDCP SDUs is performed by using ROHC and/or EHC;
      if drb-ContinueUDC is configured and previous PDCP SDUs have already been compressed, PDCP SDUs that were previously compressed for integrity protection and encryption functions are submitted; otherwise, uplink data compression on the PDCP SDUs is performed and the PDCP SDUs are submitted to the integrity protection and encryption functions;
      integrity protection and encryption for this PDCP SDU are performed by using a COUNT value associated with this PDCP SDU;
      the generated PDCP Data PDU is submitted to the lower layer.

When the upper layer requests for PDCP reestablishment, the receiving PDCP entity will:
procedure PDCP Data PDUs caused by lower layer reestablishment received from the lower layer;
for SRBs, discard all stored PDCP SDUs and PDCP PDUs;
for SRBs, UM DRBs and UM MRBs, if t-Reordering is running, stop and reset t-Reordering; and for UM DRBs and UM MRBs, after header decompression, submit all stored PDCP SDUs to the higher layer in an ascending order of associated COUNT values;
for AM DRBs and AM MRBs on a Uu port, if drb-ContinueROHC is not configured, use an ROHC protocol to perform header decompression for all stored PDCP SDUs;
for AM DRBs on a PC5 interface, use the ROHC protocol to perform header decompression for all stored PDCP IP SDUs;
for AM DRBs and AM MRBs on the Uu port, if drb-ContinueEHC-DL is not configured, use EHC to perform header decompression for all stored PDCP SDUs;
for UM DRBs, AM DRBs, UM MRBs and AM MRBs, if drb-ContinueROHC is not configured, reset a downlink ROHC protocol, and start with the NC state of U-mode defined in RFC 3095 and RFC 4815;
for UM DRBs, AM DRBs, UM MRBs and AM MRBs, if drb-ContinueEHC-DL is not configured, reset the downlink EHC protocol;
for SRBs, UM DRBs and UM MRBs, set X_NEXT and RX_DELIV as initial values;
during PDCP entity reestablishment, apply the encryption algorithm and key provided by the upper layer;
during PDCP entity reestablishment, apply the integrity algorithm and key provided by the upper layer;
and after the above procedure is completed, the terminal equipment will perform data transmission.

Regarding PDCP data recovery:
for AM DRBs, when the upper layer requests recovery of PDCP data of a radio bearer, the transmitting PDCP entity will perform retransmission of all PDCP Data PDUs previously submitted to a reestablished or released AM RLC entity and having not been confirmed as successfully transmitted by the lower layer in an ascending order of the associated COUNT values.

After the above procedure is completed, the terminal equipment will perform data transmission.

Regarding RLC entity reestablishment:
when the upper layer requests for reestablishment of an RLC entity, the terminal will discard all RLC SDUs, RLC SDU segments and RLC PDUs, stop and reset all timers, and reset all state variables to their initial values.

Regarding MAC reset:
when the upper layer requests for resetting of an RLC entity, the MAC entity will:
1> if MAC reset is not due to SCG deactivation:
   2> initialize Bj of each logical channel to be 0;
1> if RRC configures Sidelink resource allocation mode 1, initialize SBj of each logical channel to be 0;
1> if the upper layer indicates SCG deactivation and configures bfd-and-RLM with value true for the deactivated SCG:
   2> stop all timers (if running), except for beamFailureDetectionTimer and timeAlignmentTimers associated with a PSCell;
1> otherwise,
   2> stop all timers (if running), except for MBS broadcast DRX timers;
   2> consider that all timeAlignmentTimers, inactive PosSRS TimeAlignTimer and cg-SDT-TimeAlignmentTimer (if configured) expire, and execute corresponding actions;
1> set NDIs of all uplink HARQ processes to be 0;
1> set NDIs of all HARQ procedure IDs to be 0 to monitor PDCCHs in Sidelink resource allocation mode 1;
1> stop the ongoing random access procedure, if any;
1> discard explicitly indicated contention-free random access resources (if any) of 4-step RA type and 2-step RA type;
1> clear the sg3 buffer;
1> clear MSGA buffer;
1> cancel a triggered scheduling request procedure (if any);
1> cancel a triggered buffer status reporting procedure (if any);
1> cancel a triggered power headroom reporting procedure (if any);
1> cancel a triggered consistent LBT failure (if any);
1> cancel triggered BFR (if any);
1> cancel a triggered sidelink buffer status reporting procedure (if any);
1> cancel a triggered pre-emptive buffer status reporting procedure (if any);
1> cancel a triggered timing advance reporting procedure (if any);
1> cancel a triggered recommended bit rate query procedure (if any);
1> cancel triggered configured uplink grant confirmation (if any);
1> cancel triggered configured sidelink grant confirmation (if any);
1> cancel a triggered desired guard symbol query (if any);
1> cancel a triggered positioning measurement gap activation/reactivation request procedure (if any);
1> cancel a triggered SDT procedure (if any);
1> clear all soft buffers of downlink HARQ processes, except for those used for DL HARQ processes for MBS broadcasting;
1> for each DL HARQ process, consider that next received transmission of a TB is the very first transmission;
1> release a temporary C-RNTI (if any);
1> if the upper layer indicates SCG deactivation and bfd-and-RLM with value true is not configured; or
1> ifMAC reset is not due to SCG deactivation:
   2> reset all BFI_COUNTERs;
1> reset all LBT_COUNTERs

### Regarding RRC Timer:

Operations of timers T304/T310/T312/T390 involve cell change, and details are as follows:

| Timers | Start | Stop | At expiry |
|---|---|---|---|
| T304 | Upon reception of | Upon successful | For T304 of MCG, in case of |
| | RRCReconfiguration | completion of random | the handover from NR or |
| | message including | access on the | intra-NR handover, or path |
| | reconfiguration With | corresponding SpCell; | switch from a L2 U2N Relay |
| | Sync for the MCG | For T304 of SCG, upon | UE to a NR cell, initiate the |
| | which does not include | SCG release. | RRC re-establishment |
| | sl-PathSwitchConfig, | | procedure; In case of |
| | or upon reception of | | handover to NR, perform the |
| | RRCReconfiguration | | actions defined in the |
| | message including | | specifications applicable for |
| | reconfigurationWith | | the source RAT. If any DAPS |
| | Sync for the SCG not | | bearer is configured and if |
| | indicated as | | there is no RLF in source |
| | deactivated in the | | PCell, initiate the failure |
| | NR or E-UTRA | | information procedure. |
| | message containing | | For T304 of SCG, inform |
| | the RRCReconfiguration | | network about the |
| | message or upon | | reconfiguration with sync |
| | conditional | | failure by initiating the SCG |
| | reconfiguration | | failure information procedure |
| | execution i.e. when | | as specified in 5.7.3. |
| | applying a stored | | |
| | RRCReconfiguration | | |
| | message including | | |
| | reconfigurationWith | | |
| | Sync. | | |
| T310 | Upon detecting | Upon receiving N311 | If the T310 is kept in MCG: If |
| | physical layer | consecutive in-sync | AS security is not activated: |
| | problems for the | indications from lower | go to RRC_IDLE else: initiate |
| | SpCell i.e. upon | layers for the SpCell, upon | the MCG failure information |
| | receiving N310 | receiving | procedure as specified in |
| | consecutive | RRCReconfiguration with | 5.7.3b or the connection |
| | out-of-sync | reconfiguration WithSync | re-establishment procedure as |
| | indications from | for that cell group, upon | specified in 5.3.7 or the |
| | lower layers. | reception of | procedure as specified in |
| | | MobilityFromNRCommand, | 5.3.10.3 if any DAPS bearer |
| | | upon the reconfiguration | is configured. |
| | | of rlf-TimersAndConstant, | If the T310 is kept in SCG, |
| | | upon initiating the | Inform E-UTRAN/NR about |
| | | connection | the SCG radio link failure by |
| | | re-establishment | initiating the SCG failure |
| | | procedure, upon | information procedure as |
| | | conditional reconfiguration | specified in 5.7.3. |
| | | execution i.e. when | |
| | | applying a stored | |
| | | RRCReconfiguration | |
| | | message including | |
| | | reconfiguration WithSync | |
| | | for that cell group, and | |
| | | upon initiating the MCG | |
| | | failure information | |
| | | procedure. | |
| | | Upon SCG release, if the | |
| | | T310 is kept in SCG. | |
| T312 | If T312 is configured | Upon receiving N311 | If the T312 is kept in MCG |
| | in MCG: Upon | consecutive in-sync | initiate the MCG failure |
| | triggering a | indications from lower | information procedure as |
| | measurement report | layers for the SpCell, | specified in 5.7.3b or the |
| | for a measurement | receiving | connection re-establishment |
| | identity for which | RRCReconfiguration with | procedure. |
| | T312 has been | reconfigurationWithSync | If the T312 is kept in SCG, |
| | configured and | for that cell group, upon | Inform E-UTRAN/NR about |
| | useT312 has been set | reception of | the SCG radio link failure by |
| | to true, while T310 | MobilityFromNRCommand, | initiating the SCG failure |
| | in PCell is running. | upon initiating the | information procedure. as |
| | If T312 is configured | connection | specified in 5.7.3. |
| | in SCG and useT312 | re-establishment | |
| | has been set to true: | procedure, upon the | |
| | Upon triggering a | reconfiguration of | |
| | measurement report | rlf-TimersAndConstant, | |
| | for a measurement | upon initiating the MCG | |
| | identity for which | failure information | |
| | T312 has been | procedure, upon | |
| | configured, while | conditional reconfiguration | |
| | T310 in PSCell is | execution i.e. when | |
| | running. | applying a stored | |
| | | RRCReconfiguration | |
| | | message including | |
| | | reconfigurationWithSync | |
| | | for that cell group, and | |
| | | upon the expiry of T310 in | |
| | | corresponding SpCell. | |
| | | Upon SCG release, if the | |
| | | T312 is kept in SCG | |
| T316 | Upon transmission | Upon receiving | Perform the actions as |
| | of the | RRCRelease, | specified in 5.7.3b.5. |
| | MCGFailureInformation | RRCReconfiguration with | |
| | message | reconfigurationwithSync | |
| | | for the PCell, | |
| | | MobilityFromNRCommand, | |
| | | or upon initiating the | |
| | | re-establishment procedure | |
| T350 | Upon transmitting | Upon acquiring the | No action |
| | DedicatedSIBRequest | requested SIB(s) or | |
| | message with | posSIB(s), upon releasing | |
| | requestedSIB-List | onDemandSIB-Request | |
| | and/or | during the connection | |
| | requestedPosSIB-List. | re-establishment | |
| | | procedures, upon receiving | |
| | | onDemandSIB-Request set | |
| | | to release, upon reception | |
| | | of RRCRelease or upon | |
| | | successful change of PCell | |
| | | while in RRC_CONNECTED. | |
| T390 | When access attempt | Upon cell (re)selection, | Perform the actions as |
| | is barred at access | upon cell change due to | specified in 5.3.14.4. |
| | barring check for an | relay (re)selection, upon | |
| | Access Category. | entering RRC_CONNECTED, | |
| | The UE maintains | upon reception of | |
| | one instance of this | RRCReconfiguration | |
| | timer per Access | including | |
| | Category. | reconfigurationWithSync, | |
| | | upon change of PCell | |
| | | while in RRC_CONNECTED, | |
| | | upon reception of | |
| | | MobilityFromNRCommand, | |
| | | or upon reception of | |
| | | RRCRelease. | |

In existing mechanisms, serving cell change involves the above complete L2 reset, thereby resulting in longer latency, greater signaling overhead and longer interruption time in the beam-level mobility. In order to solve at least one of the above problems or other similar problems, embodiments of this disclosure provide a method and apparatus for cell switching.

According to a first aspect of the embodiments of this disclosure, there is provided an apparatus for cell switching, provided in a terminal equipment, the apparatus including: a first receiving unit configured to receive L1 signaling and/or L2 signaling from a first network node; and a first switch unit configured to switch a serving cell to a cell indicated by the L2 signaling and/or the L1 signaling, wherein the switching a serving cell to a cell indicated by the L2 signaling and/or the L1 signaling includes at least one of L1 partial resetting, L2 partial resetting, or processing a timer maintained by an RRC layer.

According to a second aspect of the embodiments of this disclosure, there is provided an apparatus for cell switching, applicable to a first network node, the apparatus including: a first transmitting unit configured to transmit L1 signaling and/or L2 signaling to a terminal equipment to indicate the terminal equipment to switch a serving cell to a cell indicated by the L2 signaling and/or the L1 signaling, wherein the switching a serving cell to a cell indicated by the L2 signaling and/or the L1 signaling includes at least one of partial MAC entity resetting, partial RLC reestablishment, partial PDCP reestablishment or processing a timer maintained by an RRC layer.

According to a third aspect of the embodiments of this disclosure, there is provided a terminal equipment, including the apparatus as described in the first aspect of the embodiments of this disclosure.

According to a fourth aspect of the embodiments of this disclosure, there is provided a network node, including the apparatus as described in the second aspect of the embodiments of this disclosure.

According to a fifth aspect of the embodiments of this disclosure, there is provided a communication system, including the terminal equipment as described in the third aspect of the embodiments of this disclosure and/or the network node as described in the fourth aspect of the embodiments of this disclosure.

According to a sixth aspect of the embodiments of this disclosure, there is provided a method for cell switching, applicable to a terminal equipment, the method including: receiving L1 signaling and/or L2 signaling from a first network node; and switching a serving cell to a cell indicated by the L2 signaling and/or the L1 signaling, wherein the switching a serving cell to a cell indicated by the L2 signaling and/or the L1 signaling includes at least one of L1 partial resetting, L2 partial resetting, or processing a timer maintained by an RRC layer.

According to a seventh aspect of the embodiments of this disclosure, there is provided a method for cell switching, applicable to a first network node, the method including: transmitting L1 signaling and/or L2 signaling to a terminal equipment to indicate the terminal equipment to switch a serving cell to a cell indicated by the L2 signaling and/or the L1 signaling, wherein the switching a serving cell to a cell indicated by the L2 signaling and/or the L1 signaling includes at least one of partial MAC entity resetting, partial RLC reestablishment, partial PDCP reestablishment or processing a timer maintained by an RRC layer.

According to an eighth aspect of the embodiments of this disclosure, there is provided a computer readable program code, which, when executed in an apparatus for cell switching or a terminal equipment, will cause the apparatus for cell switching or the terminal equipment to carry out the method for cell switching as described in the embodiment of the sixth aspect of this disclosure.

According to a ninth aspect of the embodiments of this disclosure, there is provided a computer readable medium, including a computer readable program code, which will cause an apparatus for cell switching or a terminal equipment to carry out the method for cell switching as described in the embodiment of the sixth aspect of this disclosure.

According to a tenth aspect of the embodiments of this disclosure, there is provided a computer readable program code, which, when executed in an apparatus for cell switching or a network node, will cause the apparatus for cell switching or the network node to carry out the method for cell switching as described in the embodiment of the seventh aspect of this disclosure.

According to an eleventh aspect of the embodiments of this disclosure, there is provided a computer readable medium, including a computer readable program code, which will cause an apparatus for cell switching or a network node to carry out the method for cell switching as described in the embodiment of the seventh aspect of this disclosure.

An advantage of the embodiments of this disclosure exists in that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communication system of an embodiment of this disclosure;

FIG. 2 is a schematic diagram of a deployment scenario of an NG-RAN;

FIG. 3 is a schematic diagram of a deployment scenario of IAB;

FIG. 4 is schematic diagram of the method for cell switching of embodiment 1 of this disclosure;

FIG. 5 is a schematic diagram of the method for cell switching of embodiment 2 of this disclosure;

FIG. 6 is a schematic diagram of the method for cell switching of embodiment 3 of this disclosure;

FIG. 7 is a schematic diagram of the apparatus for cell switching of embodiment 4 of this disclosure;

FIG. 8 is a schematic diagram of the apparatus for cell switching of embodiment 5 of this disclosure;

FIG. 9 is a block diagram of a systematic structure of the terminal equipment of embodiment 6 of this disclosure; and

FIG. 10 is a block diagram of a systematic structure of the network node of embodiment 7 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. For example, a 5G base station gNB may include a gNB-CU and one or more gNB-DUs, wherein the CU/DU is a logical node of the gNB having a part of functions of the gNB. And a term “cell” may refer to a base station and/or its coverage area, depending on a context of the term. One gNB-DU supports one or more cells, and one cell is supported by only one gNB-DU.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), or a station, etc., such as a terminal equipment served by an IAB-node or an IAB-donor under an IAB architecture.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, all of “when . . . ”, “in a case where . . . ”, “for a case where . . . ” and “if . . . ” denote one or some conditions or states, and furthermore, all of these expressions are interchangeable.

Scenarios of the embodiments of this disclosure shall be described below by way of examples; however, this disclosure is not limited thereto.

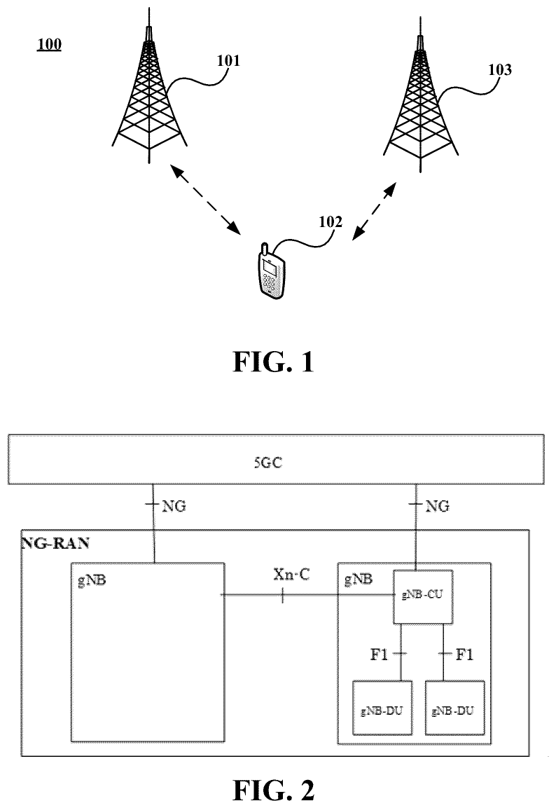

FIG. 1 is a schematic diagram of a communication system of an embodiment of this disclosure, in which a case where a terminal equipment and a network device are taken as examples is schematically shown. As shown in FIG. 1, a communication system 100 may include a first network node 101 and a terminal equipment 102.

For example, the first network node 101 is a gNB, or includes a gNB CU and one or more gNB-DU(s) connected thereto.

In an IAB network, for example, the first network node 101 may be an IAB-donor or IAB-node, or may include an IAB-donor-CU and one or more IAB-donor-DU(s) connected thereto, or may include an IAB-donor-CU and one or more IAB-node-DU (s) connected thereto via other nodes.

When the terminal equipment 102 performs cell change, the first network node 101 serves as a source network node, and at the same time, it serves as a target network node; or, as shown in FIG. 1, the communication system 100 may also include a second network node 103, in which case when the terminal equipment 102 performs cell change, the first network node 101 is a source network node, and the second network node 103 is a target network node.

For the sake of simplicity, an example having only one terminal equipment is schematically given in FIG. 1.

In the embodiments of this disclosure, for inter-gNB cell changes, i.e. inter-gNB-CU cell changes, the first network node 101 and the second network node 103 are, for example, NR gNBs.

For inter-gNB-DU cell changes, the first network node 101 and the second network node 103 are different gNB-DUs within the same gNB-CU.

For intra-gNB-DU cell changes, the first network node 101 and the second network node 103 are different TRPs or repeaters within the same gNB-DU; or, the first network node 101 is both a source network node and a target network node, and a source cell and a target cell are both located on the first network node 101, in which case the communication system 100 of the embodiment of this disclosure includes the first network node 101 and the terminal equipment 102.

In the embodiments of this disclosure, FIG. 1 represents an IAB network, in which the terminal equipment 102 may either be a UE or an IAB-MT.

For inter-IAB-donor-CU cell changes, the first network node 101 and the second network node 103 are different IAB-donor-CUs, that is, when the terminal equipment 102 needs to perform cell change, the first network node 101 is a source IAB-donor-CU, and the second network node 103 is a target IAB-donor-CU.

For inter-IAB-donor-DU cell changes within an IAB-donor-CU, the first network node 101 and the second network node 103 are different IAB-donor-DUs within the same IAB-donor-CU, that is, when the terminal equipment 102 needs to perform cell change, the first network node 101 is a source IAB-donor-DU, and the second network node 103 is a target IAB-donor-DU.

For inter-IAB-node cell changes, the communication system 100 of the embodiment of this disclosure includes a first network node 101 and a terminal equipment 102. When the terminal equipment 102 needs to perform cell change, the first network node 101 is a source IAB-donor-DU, and is also a target IAB-donor-DU.

In the embodiment of this disclosure, existing services or services that may be implemented in the future may be performed between the first network node 101 and/or the second network node 103 and the terminal equipment 102. For example, such services may include but not limited to an enhanced mobile broadband (eMBB), massive machine type communication (mMTC), and ultra-reliable and low-latency communication (URLLC), etc.

The methods for cell switching in the embodiments of this disclosure may be applicable to various deployment scenarios, such as deployment scenarios of NG-RAN, and IAB, etc.

FIG. 2 is a schematic diagram of a deployment scenario of NG-RAN of an embodiment of this disclosure. As shown in FIG. 2, the NG-RAN includes a group of gNBs connected to a 5GC via an NG interface. The gNBs may be interconnected via an Xn interface. A gNB may include one gNB-CU and one or more gNB-DU(s), a gNB-CU and a gNB-DU are connected via an F1 interface, and one gNB-DU may only be connected to one gNB-CU.

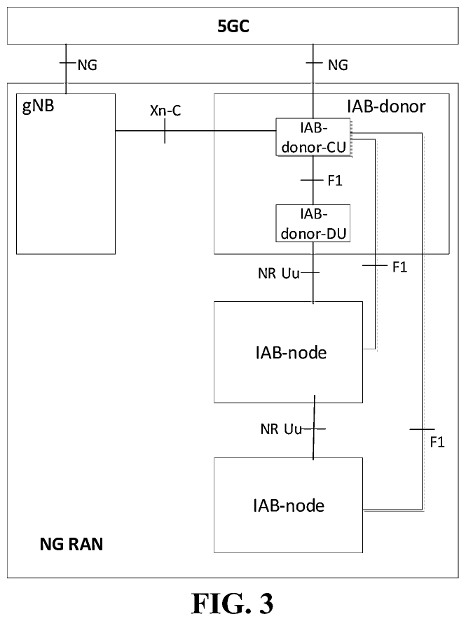

FIG. 3 is a schematic diagram of a deployment scenario of IAB of an embodiment of this disclosure. As shown in FIG. 3, the NG-RAN may be wirelessly connects to a gNB that is able to serve for IAB-nodes via the IAB nodes, referred to as an IAB-donor, to support IAB. The IAB-donor includes one IAB-donor-CU and one or more IAB-donor-DU(s).

Unless otherwise specified, all functions defined for a gNB-DU are equally applicable to an IAB-DU and a IAB-donor-DU, all functions defined for a gNB-CU are equally applicable to an IAB-donor-CU, and all functions defined for a UE are equally applicable to an IAB-MT.

Various implementations of the embodiments of this disclosure shall be described below with reference to the accompanying drawings. These implementations are illustrative only, and are not intended to limit this disclosure.

### Embodiment 1

The embodiment of this disclosure provides a method for cell switching, applicable to a terminal equipment, such as the terminal equipment 102 in FIG. 1.

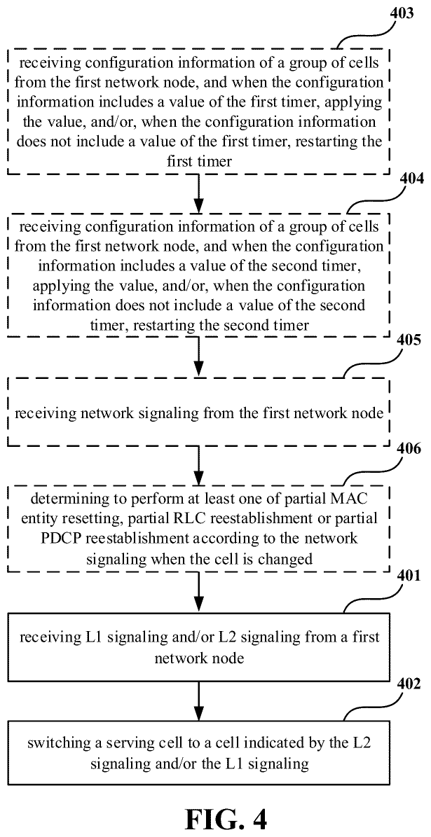

FIG. 4 is a schematic diagram of the method for cell switching of embodiment 1 of this disclosure. As shown in FIG. 4, the method includes:
step 401: receiving L1 signaling and/or L2 signaling from a first network node; and
step 402: switching a serving cell to a cell indicated by the L2 signaling and/or the L1 signaling,
wherein the switching a serving cell to a cell indicated by the L2 signaling and/or the L1 signaling includes at least one of L1 partial resetting, L2 partial resetting, or processing a timer maintained by an RRC layer.

Hence, the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

In the embodiments of this disclosure, the cell change (switch) includes at least one of serving cell change (switch), special cell change and primary cell change.

In the embodiments of this disclosure, the source cell and target cell in the cell change are synchronous or asynchronous.

In the embodiments of this disclosure, the source cell and target cell in the cell change are of intra-frequency or inter-frequency.

In the embodiments of this disclosure, the source cell and/or the target cell in the cell change operate(s) at FR1 or FR2.

In the embodiments of this disclosure, the first network node is a source network node, i.e. a network node to which a source cell belongs.

In the embodiments of this disclosure, L1 refers to layer 1, including, for example, a physical layer;
L2 refers to layer 2, including, for example, an MAC layer or MAC sublayer, a PDCP layer or PDCP sublayer, and an RLC layer or RLC sublayer;
and L3 refers to layer 3, including, for example, an RRC layer.

In step 401, the terminal equipment receives L1 signaling and/or L2 signaling from the first network node. In step 402, the terminal equipment switches the current serving cell to the cell indicated by the L2 signaling and/or the L1 signaling.

For example, the terminal equipment receives L1 signaling from the first network node, and switches the current serving cell to the cell indicated by L1 signaling.

For example, the terminal equipment receives L2 signaling from the first network node, and switches the current serving cell to the cell indicated by L2 signaling.

For example, the terminal equipment receives L2 signaling and L1 signaling from the first network node, wherein L2 signaling includes multiple indicated cells, L1 signaling indicates one cell in the multiple cells, and the terminal equipment switches the current serving cell to the cell indicated by L1 signaling.

In the embodiments of this disclosure, the L1 signaling is downlink control information (DCI).

In the embodiments of this disclosure, the L2 signaling is an MAC CE.

In the embodiments of this disclosure, the L1 signaling indicates at least one of the following:
cell information;
a TCI state ID, e.g. the L1 signaling reuses DCI for existing TCI state ID indication or uses a updated DCI based on existing TCI state ID indication;
TA information;
a UE identifier assigned by the target cell for the terminal equipment, such as a C-RNTI;
HARQ feedback information of the L1 signaling; and
scheduling information, such as including a UL grant and/or a DL assignment in the target cell.

In the embodiments of this disclosure, the L2 signaling indicates at least one of the following:
cell information;
TCI state identifier (TCI state ID), e.g. the L2 signaling reuses MAC CE for existing TCI state ID indication or uses a updated DCI based on existing TCI state ID indication;
TA information;
a UE identifier assigned by the target cell for the terminal equipment, such as a C-RNTI;
HARQ feedback information of the L2 signaling; and
scheduling information, such as including a UL grant and/or a DL assignment in the target cell.

For example, the terminal equipment receives L2 signaling and L1 signaling from the first network node, and switches the current serving cell to the cell indicated by the L2 signaling and the L1 signaling, wherein L2 signaling and L1 signaling indicate different information of the same cell, for example, L1 signaling indicates the TCI state ID of the cell, and L2 signaling indicates the TA information of the cell.

In the embodiments of this disclosure, the switching the serving cell to the cell indicated by the L2 signaling and/or the L1 signaling includes at least one of partially resetting L1, partially resetting L2, and processing a timer maintained by an RRC layer.

In the embodiments of this disclosure, the partially resetting L1 refers to performing a part of L1 reset, and L2 partial reset refers to performing a part of L2 reset.

In the embodiments of this disclosure, the partially resetting L2 includes at least one of resetting a part of MAC entities, reestablishing a part of RLC, and reestablishing a part of PDCPs.

In the embodiments of this disclosure, the processing a timer maintained by an RRC layer includes: starting or restarting the timer maintained by the RRC layer, and/or stopping the timer maintained by the RRC layer.

In the embodiments of this disclosure, the starting or restarting the timer maintained by the RRC layer includes starting or restarting a switching timer, such as T304.

In the embodiments of this disclosure, the stopping the timer maintained by the RRC layer includes at least one of the following actions:
stopping a timer related to radio link monitoring, such as T310 in a group or T312 in a group;
stopping a timer related to failure reporting, such as T316; and
stopping a timer related to an access attempt, such as T390.

In the embodiments of this disclosure, the resetting a part of MAC entities includes at least one of the following actions:
for a first timer, applying a value of the first timer or restarting the first timer;
not considering that a TA (time alignment)-related timer expires;
not canceling a triggered BSR procedure; and
not clearing a soft buffer of a downlink HARQ process.

In the embodiments of this disclosure, as shown in FIG. 4, the method further includes:
step 403: receiving configuration information of a group of cells from the first network node, and when the configuration information includes a value of the first timer, applying the value, and/or, when the configuration information does not include a value of the first timer, restarting the first timer.

For example, the group of cells is candidate cells for performing a cell change procedure based on L1 signaling and/or L2 signaling.

In the embodiments of this disclosure, the restarting the first timer includes restarting the first timer and using a previous value.

That is, if the indicated configuration information includes the value of the first timer, the terminal equipment applies the new value; otherwise, the first timer is restarted and the terminal equipment uses the previous value, i.e. a value configured by the serving cell before the handover is performed.

For example, the first timer is the timer maintained by the MAC layer.

In the embodiments of this disclosure, the reestablishing a part of RLC includes at least one of the following actions:
not discarding RLC SDUs, RLC SDU segments and RLC PDUs; and
for a second timer, applying a value of the second timer or restarting the second timer.

In the embodiments of this disclosure, as shown in FIG. 4, the method further includes:
step 404: receiving configuration information of a group of cells from the first network node, and when the configuration information includes a value of the second timer, applying the value, and/or, when the configuration information does not include a value of the second timer, restarting the second timer.

For example, the group of cells is candidate cells for performing a cell change procedure based on L1 signaling and/or L2 signaling.

In the embodiments of this disclosure, step 404 and step 403 are optional, and furthermore, step 404 and step 403 may be executed in a combined manner.

In the embodiments of this disclosure, restarting the second timer includes restarting the second timer and using a previous value.

For example, the second timer is a timer maintained by the RLC layer.

In the embodiments of this disclosure, the partial PDCP reestablishment includes at least one of the following actions: reestablishing a PDCP without key updating, and not performing data recovery.

In the embodiments of this disclosure, the reestablishing a PDCP without key updating includes:
continuing to apply same encryption algorithm and key as a source cell by a transmitting PDCP entity, and/or continuing to apply same integrity algorithm and key as the source cell by the transmitting PDCP entity.

In the embodiments of this disclosure, the reestablishing a PDCP without key updating further includes:
that the transmitting PDCP entity will execute at least one of the following:
for UM DRB and/or AM DRB, continuing a current ROCH;
for UM DRB and/or AM DRB, continuing with a current EHC; and
for AM DRB, continuing to discard UDC.

In the embodiments of this disclosure, the reestablishing a PDCP without key updating includes:
continuing to apply same encryption algorithm and key as a source cell by a receiving PDCP entity, and/or continuing to apply same integrity algorithm and key as the source cell by the receiving PDCP entity.

In the embodiments of this disclosure, the reestablishing a PDCP without key updating further includes:
for UM DRB and/or AM DRB, continuing with a current ROCH by the receiving PDCP entity.

In the embodiments of this disclosure, as shown in FIG. 4, the method further includes:
step 405: receiving network signaling from the first network node; and
step 406: determining to perform at least one of partial MAC entity resetting, partial RLC reestablishment or partial PDCP reestablishment according to the network signaling when the cell is changed.

In the embodiments of this disclosure, step 405 and step 406 are optional. Furthermore, an order of executing steps 405 and 406 and steps 403 and 404 is not limited, and they also be executed in a combined manner.

In the embodiments of this disclosure, when the network command includes an indication for ROCH reset, the terminal equipment resets the ROCH protocol. That is, the indication for ROCH reset is used to indicate the terminal equipment to reset the ROCH protocol.

In the embodiments of this disclosure, when the network command does not include an indication for ROCH reset, the terminal equipment does not reset the ROCH protocol or continues with the current ROCH.

In the embodiments of this disclosure, when the network command includes a first indication for ROCH reset, the transmitting PDCP entity of the terminal equipment resets an uplink ROCH protocol. That is, the first indication for ROCH reset is used to indicate the transmitting PDCP entity of the terminal equipment to reset the uplink ROCH protocol.

In the embodiments of this disclosure, when the network command does not include the first indication for ROCH reset, the transmitting PDCP entity of the terminal equipment does not reset the uplink ROCH protocol or continues with the current uplink ROCH.

In the embodiments of this disclosure, when the network command includes a second indication for ROCH reset, the receiving PDCP entity of the terminal equipment resets the downlink ROCH protocol. That is, the second indication for ROCH reset is used to indicate the receiving PDCP entity of the terminal equipment to reset the downlink ROCH protocol.

In the embodiments of this disclosure, when the network command does not include a second indication for ROCH reset, the receiving PDCP entity of the terminal equipment does not reset the downlink ROCH protocol or continues with the current downlink ROCH.

In the embodiments of this disclosure, when the network command includes a third indication for EHC reset, the transmitting PDCP entity of the terminal equipment resets the uplink EHC protocol. That is, the third indication for EHC reset is used to indicate the transmitting PDCP entity of the terminal equipment to reset the uplink EHC protocol.

In the embodiments of this disclosure, when the network command does not include a third indication for EHC reset, the transmitting PDCP entity of the terminal equipment does not reset the uplink EHC protocol or continues with the current uplink EHC.

In the embodiments of this disclosure, when the network command includes a fourth indication for stopping UDC discarding, the transmitting PDCP of the terminal equipment does not continue to discard UDC. That is, the fourth indication for stopping UDC discarding is used to indicate the transmitting PDCP of the terminal equipment not to continue to discard UDC.

In the embodiments of this disclosure, when the network command does not include a fourth indication for stopping UDC discarding, the transmitting PDCP entity of the terminal equipment continues to discard UDC.

In the embodiments of this disclosure, when the network command includes a fifth indication for updating an encryption algorithm and key, the transmitting PDCP and/or receiving PDCP of the terminal equipment update(s) the encryption algorithm and key. That is, the fifth indication for updating encryption algorithms and keys is used to indicate the transmitting PDCP and/or receiving PDCP of the terminal equipment to update an encryption algorithm and key.

In the embodiments of this disclosure, when the network command does not include a fifth indication for updating an encryption algorithm and key, the transmitting PDCP and/or receiving PDCP of the terminal equipment continues to apply an encryption algorithm and key identical to that of the source cell.

In the embodiments of this disclosure, when the network command includes a sixth indication for updating an integrity algorithm and key, the transmitting PDCP and/or receiving PDCP of the terminal equipment update(s) an integrity algorithm and key. That is, the sixth indication for updating an integrity algorithm and key is used to indicate the transmitting PDCP and/or receiving PDCP of the terminal equipment to update an integrity algorithm and key.

In the embodiments of this disclosure, when the network command does not include the sixth indication for updating the integrity algorithm and key, the transmitting PDCP and/or receiving PDCP of the terminal equipment continues to apply an integrity algorithm and key identical to that of the source cell.

In the embodiments of this disclosure, the network signaling includes at least one of an RRC message, an MAC CE, and DCI.

In the embodiments of this disclosure, a granularity of the network signaling is: per terminal equipment, per cell, per cell group, per bearer, or per HARQ process.

For example, that the granularity of the network signaling is per terminal equipment includes that the network signaling and/or an indication included in the network signaling is/are applicable to the terminal equipment.

For example, that the granularity of the network signaling is per cell includes that the network signaling and/or an indication included in the network signaling is/are applicable to the cell.

For example, that the granularity of the network signaling is per cell group includes that the network signaling and/or an indication included in the network signaling is/are applicable to the cell group.

For example, that the granularity of the network signaling is per bearer includes that the network signaling and/or an indication included in the network signaling is applicable to the bearer.

For example, that the granularity of the network signaling is per HARQ procedure includes that the network signaling and/or an indication included in the network signaling is/are applicable to the HARQ process.

The method for cell switching in the embodiment of this disclosure shall be exemplified below with reference to operations of timers.

### (1) Operations of Timer T304

For timer T304, starting the timer is as follows:

| | |
|---|---|
| 5.3.5.5.2 | Reconfiguration with sync |

The UE shall perform the following actions to execute a reconfiguration with sync.
......

| 1> | else (sl-PathSwitchConfig is not included): | |
|---|---|---|
| | 2> | if this procedure is executed for the MCG or if this procedure is executed for an SCG |

| not indicated as deactivated in the E-UTRA or NR RRC message in which the | |
|---|---|
| RRCReconfiguration message is embedded: | |
| 3> | start timer T304 for the corresponding SpCell with the timer value set to t304, as |

included in the reconfigurationWithSync;

Stopping the timer is as follows:

| | |
|---|---|
| 5.3.5.3 | Reception of an RRCReconfiguration by the UE |

The UE shall perform the following actions upon reception of the RRCReconfiguration, or upon
execution of the conditional reconfiguration (CHO, CPA or CPC):
......

| 1> | if reconfigurationWithSync was included in spCellConfig of an MCG or SCG: | |
|---|---|---|
| | 2> | if sl-PathSwitchConfig was included in reconfigurationWithSync: |

| | |
|---|---|
| 3> | stop timer T420 upon successfully sending RRCReconfigurationComplete message |

(i.e., PC5 RLC acknowledgement is received from target L2 U2N Relay UE);

| | |
|---|---|
| 2> | else: |

| 3> | when MAC of an NR cell group successfully completes a Random Access |
|---|---|
| | procedure triggered above: |
| 3> | stop timer T304 for that cell group; |

| | |
|---|---|
| 2> | stop timer T310 for source SpCell if running; |

In the embodiments of this disclosure, when the L1 signaling and/or the L2 signaling is/are received, or when RRC receives an indication from a lower layer, or when a special cell changes, timer T304 of a corresponding SpCell is started, and optionally, its timer value is set to be a value configured by the network; wherein the indication from the lower layer may indicate at least one of the following: serving cell change, timer start and switch. Wherein, L1 signaling and/or L2 signaling or the indication from the lower layer is/are associated with a special cell of an MCG or SCG.

In the embodiments of this disclosure, when the terminal equipment successfully completes switch the serving cell to the indicated cell, timer T304 of this cell group is stopped.

### (2) Operations of Timer T310

For timer T310, stopping the timer is as follows:

| | |
|---|---|
| 5.3.5.3 | Reception of an RRCReconfiguration by the UE |

The UE shall perform the following actions upon reception of the RRCReconfiguration, or upon
execution of the conditional reconfiguration (CHO, CPA or CPC):
......

| 1> | if reconfigurationWithSync was included in spCellConfig of an MCG or SCG: | |
|---|---|---|
| | 2> | if sl-PathSwitchConfig was included in reconfiguration WithSync: |

| | |
|---|---|
| 3> | stop timer T420 upon successfully sending RRCReconfigurationComplete message |

(i.e., PC5 RLC acknowledgement is received from target L2 U2N Relay UE);

| | |
|---|---|
| 2> | else: |

| 3> | when MAC of an NR cell group successfully completes a Random Access procedure |
|---|---|
| | triggered above: |
| 3> | stop timer T304 for that cell group; |

| | |
|---|---|
| 2> | stop timer T310 for source SpCell if running; |

In the embodiments of this disclosure, when the L1 signaling and/or the L2 signaling is/are received, or when RRC receives an indication from a lower layer, or when a special cell changes, timer T310 of a source SpCell is stopped if it is running; wherein the indication from the lower layer may indicate at least one of the following: serving cell change, timer stop and switch. Wherein, the L1 signaling and/or the L2 signaling or the indication from the lower layer is/are associated with a special cell of an MCG or SCG.

### (3) Operations of Timer T312

For timer T312, stopping the timer is as follows:

| | |
|---|---|
| 5.3.5.5.2 | Reconfiguration with sync |

The UE shall perform the following actions to execute a reconfiguration with sync.

| 1> | if the AS security is not activated, perform the actions upon going to RRC_IDLE as | |
|---|---|---|
| | specified in 5.3.11 with the release cause ‘other’ upon which the procedure ends; | |
| 1> | if no DAPS bearer is configured: | |
| | 2> | stop timer T310 for the corresponding SpCell, if running; |
| 1> | if this procedure is executed for the MCG: | |
| | 2> | if timer T316 is running; |
| | | 3> stop timer T316; |
| | | 3> clear the information included in VarRLF-Report, if any; |
| | 2> | resume MCG transmission, if suspended. |

| | |
|---|---|
| 1> | stop timer T312 for the corresponding SpCell, if running; |

In the embodiments of this disclosure, when the L1 signaling and/or the L2 signaling is/are received, or when RRC receives an indication from a lower layer, or when a special cell changes, timer T312 of a corresponding SpCell is stopped if it is running; wherein the indication from the lower layer may indicate at least one of the following: serving cell change, timer stop and switch.

(4) Operations of Timer T350 and/or T390

For timer T390 and/or T390, stopping the timer is as follows:

| | |
|---|---|
| 5.3.5.3 | Reception of an RRCReconfiguration by the UE |

The UE shall perform the following actions upon reception of the RRCReconfiguration, or upon
execution of the conditional reconfiguration (CHO, CPA or CPC):
......

| 1> | if reconfigurationWithSync was included in spCellConfig of an MCG or SCG: | |
|---|---|---|
| | 2> | if sl-PathSwitchConfig was included in reconfigurationWithSync: |

| | |
|---|---|
| 3> | stop timer T420 upon successfully sending RRCReconfigurationComplete message |
| | (i.e., PC5 RLC acknowledgement is received from target L2 U2N Relay UE); |

| | |
|---|---|
| 2> | else: |

| | |
|---|---|
| 3> | when MAC of an NR cell group successfully completes a Random Access procedure |
| | triggered above: |
| 3> | stop timer T304 for that cell group; |

| | |
|---|---|
| 2> | stop timer T310 for source SpCell if running; |
| 2> | apply the parts of the CSI reporting configuration, the scheduling request configuration |
| | and the sounding RS configuration that do not require the UE to know the SFN of the |
| | respective target SpCell, if any; |
| 2> | apply the parts of the measurement and the radio resource configuration that require the |
| | UE to know the SFN of the respective target SpCell (e.g. measurement gaps, periodic |
| | CQI reporting, scheduling request configuration, sounding RS configuration), if any, |
| | upon acquiring the SFN of that target SpCell; |
| 2> | for each DRB configured as DAPS bearer, request uplink data switching to the PDCP |
| | entity, as specified in TS 38.323 [5]; |
| 2> | if the reconfigurationWithSync was included in spCellConfig of an MCG: |

| | |
|---|---|
| 3> | if T390 is running: |

| | |
|---|---|
| 4> | stop timer T390 for all access categories; |
| 4> | perform the actions as specified in 5.3.14.4. |

| | |
|---|---|
| 3> | if T350 is running: |

| | |
|---|---|
| 4> | stop timer T350; |

| | |
|---|---|
| 3> | if RRCReconfiguration does not include dedicatedSIB1-Delivery and |
| 3> | if the active downlink BWP, which is indicated by the firstActiveDownlinkBWP-Id |
| | for the target SpCell of the MCG, has a common search space configured by |
| | searchSpaceSIB1: |

| | |
|---|---|
| 4> | acquire the SIB1, which is scheduled as specified in TS 38.213 [13], of the target |
| | SpCell of the MCG; |
| 4> | upon acquiring SIB1, perform the actions specified in clause 5.2.2.4.2; |

In the embodiments of this disclosure, for T390, when the L1 signaling and/or the L2 signaling is/are received, or when RRC receives an indication from a lower layer, if T390 is running, timer T390 is stopped for all access categories; wherein the indication from the lower layer may indicate at least one of the following: serving cell change, timer stop and switch. Wherein, the L1 signaling and/or the L2 signaling or the indication from the lower layer is/are associated with a special cell of an MCG.

In the embodiments of this disclosure, for T350, when the L1 signaling and/or the L2 signaling is/are received, or when RRC receives an indication from a lower layer, if T350 is running, timer T350 is stopped; wherein the indication from the lower layer may indicate at least one of the following: serving cell change, timer stop and switch. Wherein, the L1 signaling and/or the L2 signaling or the indication from the lower layer is/are associated with a special cell of an MCG.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 2

The embodiment of this disclosure provides a method for cell switching, corresponding to the method for cell switching applicable to a terminal equipment described in embodiment 1. reference may be made to the disclosure contained in embodiment 1 for identical or corresponding contents.

This method is applicable to a first network node and/or a network node or network element connected to the first network node. For example, this method is applicable to the first network node 101 in FIG. 1.

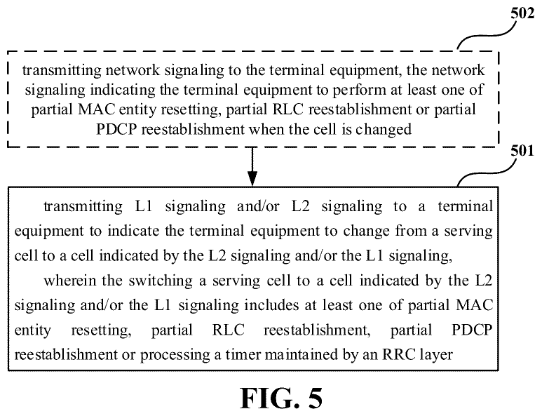

FIG. 5 is a schematic diagram of the method for cell switching in embodiment 2 of this disclosure. As shown in FIG. 5, the method includes:
step 501: transmitting L1 signaling and/or L2 signaling to a terminal equipment to indicate the terminal equipment to switch a serving cell to a cell indicated by the L2 signaling and/or the L1 signaling,
wherein the switching a serving cell to a cell indicated by the L2 signaling and/or the L1 signaling includes at least one of partial MAC entity resetting, partial RLC reestablishment, partial PDCP reestablishment or processing a timer maintained by an RRC layer.

In the embodiments of this disclosure, as shown in FIG. 5, the method further includes:
step 502: transmitting network signaling to the terminal equipment, the network signaling indicating the terminal equipment to perform at least one of partial MAC entity resetting, partial RLC reestablishment or partial PDCP reestablishment when the cell is changed.

In the embodiments of this disclosure, step 502 is optional.

In the embodiments of this disclosure, the network signaling includes at least one of the following:
an indication for ROCH resetting,
an indication for EHC resetting,
an indication for stopping UDC discarding,
an indication for updating an encryption algorithm and key; or
an indication for updating an integrity algorithm and key.

For example, the indication for ROCH resetting is used to indicate resetting of uplink ROCH and/or downlink ROCH.

In the embodiments of this disclosure, the indication for ROCH resetting includes an indication indicating resetting of uplink ROCH and downlink ROCH.

In the embodiments of this disclosure, the indication for resetting of ROCH includes a first indication and a second indication, the first indication indicating resetting of the uplink ROCH, and the second indication indicating resetting of the downlink ROCH.

In the embodiments of this disclosure, the indication for EHC resetting is used to indicate resetting of an uplink EHC protocol.

In the embodiments of this disclosure, the network signaling includes at least one of an RRC message, an MAC CE, and DCI.

In the embodiments of this disclosure, a granularity of the network signaling is: per terminal equipment, per cell, per cell group, per bearer, or per HARQ process.

For example, that the granularity of the network signaling is per terminal equipment includes that the network signaling and/or an indication included in the network signaling is/are applicable to the terminal equipment.

For example, that the granularity of the network signaling is per cell includes that the network signaling and/or an indication included in the network signaling is/are applicable to the cell.

For example, that the granularity of the network signaling is per cell group includes that the network signaling and/or an indication included in the network signaling is/are applicable to the cell group.

For example, that the granularity of the network signaling is per bearer includes that the network signaling and/or an indication included in the network signaling is applicable to the bearer.

For example, that the granularity of the network signaling is per HARQ procedure includes that the network signaling and/or an indication included in the network signaling is/are applicable to the HARQ process.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 3

The embodiment of this disclosure provides a method for cell switching. This method is applicable to a terminal equipment and a first network node, and corresponds to the method for cell switching applicable to a terminal equipment described in embodiment 1 and the method for cell switching applicable to a first network node described in embodiment 2, with identical contents being not going to be described herein any further.

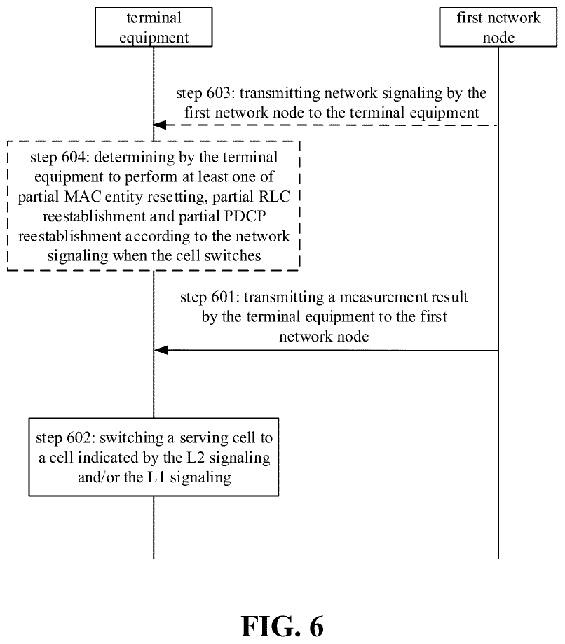

FIG. 6 is a schematic diagram of the method for cell switching in embodiment 3 of this disclosure. As shown in FIG. 6, the method includes:
step 601: transmitting a measurement result by the terminal equipment to the first network node; and
step 602: switching a serving cell to a cell indicated by the L2 signaling and/or the L1 signaling,
wherein the switching the serving cell to the cell indicated by the L2 signaling and/or the L1 signaling includes at least one of L1 partial resetting, L2 partial resetting and processing a timer maintained by an RRC layer.

In the embodiments of this disclosure, as shown in FIG. 6, the method further includes:
step 603: transmitting network signaling by the first network node to the terminal equipment; and
step 604: determining by the terminal equipment to perform at least one of partial MAC entity resetting, partial RLC reestablishment and partial PDCP reestablishment according to the network signaling when the cell switches.

In the embodiments of this disclosure, step 603 and step 604 are optional.

In the embodiment of this disclosure, reference may be made to the disclosure contained in embodiment 1 and embodiment 2 for implementations of steps 601-604, which shall not be repeated herein any further.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 4

The embodiment of this disclosure provides an apparatus for cell switching, applicable to a terminal equipment. As a principle of the apparatus for solving problems is similar to that of the method in embodiment 1, reference may be made to the implementation of the method described in embodiment 1 for implementation of the apparatus, with identical or related contents being not going to be described herein any further.

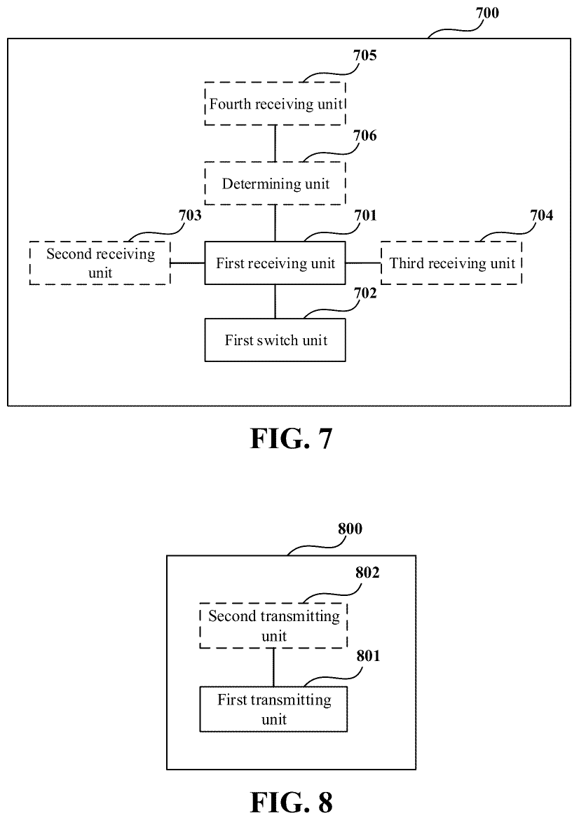

FIG. 7 is a schematic diagram of the apparatus for apparatus for cell switching of embodiment 4 of this disclosure. As shown in FIG. 7, an apparatus 700 includes:
a first receiving unit 701 configured to receive L1 signaling and/or L2 signaling from a first network node; and
a first switch unit 702 configured to switch a serving cell to a cell indicated by the L2 signaling and/or the L1 signaling,
wherein the switching a serving cell to a cell indicated by the L2 signaling and/or the L1 signaling comprises at least one of L1 partial resetting, L2 partial resetting, or processing a timer maintained by an RRC layer.

In the embodiments of this disclosure, the L2 partial resetting includes at least one of partial MAC entity resetting, partial RLC reestablishment, and partial PDCP reestablishment.

In the embodiments of this disclosure, the processing a timer maintained by an RRC layer includes: starting or restarting the timer maintained by the RRC layer, and/or stopping the timer maintained by the RRC layer.

In the embodiments of this disclosure, the starting or restarting the timer maintained by the RRC layer includes: starting or restarting a handover timer.

In the embodiments of this disclosure, the stopping the timer maintained by the RRC layer includes at least one of the following actions:
stopping a timer related to radio link monitoring;
stopping a timer related to failure reporting; or
stopping a timer related to an access attempt.

In the embodiments of this disclosure, the partial MAC entity resetting includes at least one of the following actions:
for a first timer, applying a value of the first timer or restarting the first timer;
not considering that a TA-related timer expires;
not cancelling a triggered BSR procedure; or
not clearing a soft buffer of a downlink HARQ process.

In the embodiments of this disclosure, as shown in FIG. 7, the apparatus further includes:
a second receiving unit 703 configured to receive configuration information of a group of cells from the first network node,
and when the configuration information includes a value of the first timer, the value is applied; and/or,
when the configuration information does not include a value of the first timer, the first timer is restarted.

In the embodiments of this disclosure, the restarting the first timer includes: restarting the first timer and using a previous value.

In the embodiments of this disclosure, the first timer is a timer maintained by an MAC layer.

In the embodiments of this disclosure, the partial RLC reestablishment includes at least one of the following actions:
not discarding RLC SDUs, RLC SDU segments and RLC PDUs; or
for a second timer, applying a value of the second timer or restarting the second timer.

In the embodiments of this disclosure, as shown in FIG. 7, the apparatus further includes:
a third receiving unit 704 configured to receive configuration information of a group of cells from the first network node,
and when the configuration information includes a value of the second timer, the value is applied; and/or,
when the configuration information does not include a value of the second timer, the second timer is restarted.

In the embodiments of this disclosure, the restarting the second timer includes: restarting the second timer and using a previous value.

In the embodiments of this disclosure, the second timer is a timer maintained by an RLC layer.

In the embodiments of this disclosure, the partial PDCP reestablishment includes at least one of the following actions:
reestablishing a PDCP without key updating; or
not performing data recovery.

In the embodiments of this disclosure, the reestablishing a PDCP without key updating includes:
continuing to apply same encryption algorithm and key as a source cell by a transmitting PDCP entity, and/or continuing to apply same integrity algorithm and key as the source cell by the transmitting PDCP entity.

In the embodiments of this disclosure, the reestablishing a PDCP without key updating further includes:
that the transmitting PDCP entity will execute at least one of the following:
for UM DRB and/or AM DRB, continuing a current ROCH;
for UM DRB and/or AM DRB, continuing with a current EHC; and
for AM DRB, continuing to discard UDC.

In the embodiments of this disclosure, the reestablishing a PDCP without key updating includes:
continuing to apply same encryption algorithm and key as a source cell by a receiving PDCP entity, and/or continuing to apply same integrity algorithm and key as the source cell by the receiving PDCP entity.

In the embodiments of this disclosure, the reestablishing a PDCP without key updating further includes:
for UM DRB and/or AM DRB, continuing with a current ROCH by the receiving PDCP entity.

In the embodiments of this disclosure, as shown in FIG. 7, the apparatus further includes:
a fourth receiving unit 705 configured to receive network signaling from the first network node; and
a determining unit 706 configured to determine to perform at least one of partial MAC entity resetting, partial RLC reestablishment or partial PDCP reestablishment according to the network signaling when the cell is changed.

In the embodiments of this disclosure, when the network command includes an indication for ROCH reset, the terminal equipment resets the ROCH protocol.

In the embodiments of this disclosure, when the network command does not include an indication for ROCH reset, the terminal equipment does not reset the ROCH protocol or continues with the current ROCH.

In the embodiments of this disclosure, when the network command includes a first indication for ROCH reset, the transmitting PDCP entity of the terminal equipment resets an uplink ROCH protocol.

In the embodiments of this disclosure, when the network command does not include the first indication for ROCH reset, the transmitting PDCP entity of the terminal equipment does not reset the uplink ROCH protocol or continues with the current uplink ROCH.

In the embodiments of this disclosure, when the network command includes a second indication for ROCH reset, the receiving PDCP entity of the terminal equipment resets the downlink ROCH protocol.

In the embodiments of this disclosure, when the network command does not include a second indication for ROCH reset, the receiving PDCP entity of the terminal equipment does not reset the downlink ROCH protocol or continues with the current downlink ROCH.

In the embodiments of this disclosure, when the network command includes a third indication for EHC reset, the transmitting PDCP entity of the terminal equipment resets the uplink EHC protocol.

In the embodiments of this disclosure, when the network command does not include a third indication for EHC reset, the transmitting PDCP entity of the terminal equipment does not reset the uplink EHC protocol or continues with the current uplink EHC.

In the embodiments of this disclosure, when the network command includes a fourth indication for stopping UDC discarding, the transmitting PDCP of the terminal equipment does not continue to discard UDC.

In the embodiments of this disclosure, when the network command does not include a fourth indication for stopping UDC discarding, the transmitting PDCP entity of the terminal equipment continues to discard UDC.

In the embodiments of this disclosure, when the network command includes a fifth indication for updating an encryption algorithm and key, the transmitting PDCP and/or receiving PDCP of the terminal equipment update(s) the encryption algorithm and key.

In the embodiments of this disclosure, when the network command does not include a fifth indication for updating an encryption algorithm and key, the transmitting PDCP and/or receiving PDCP of the terminal equipment continues to apply an encryption algorithm and key identical to that of the source cell.

In the embodiments of this disclosure, when the network command includes a sixth indication for updating an integrity algorithm and key, the transmitting PDCP and/or receiving PDCP of the terminal equipment update(s) an integrity algorithm and key.

In the embodiments of this disclosure, when the network command does not include the sixth indication for updating the integrity algorithm and key, the transmitting PDCP and/or receiving PDCP of the terminal equipment continues to apply an integrity algorithm and key identical to that of the source cell.

In the embodiments of this disclosure, the network signaling includes at least one of an RRC message, an MAC CE, and DCI.

In the embodiments of this disclosure, a granularity of the network signaling is: per terminal equipment, per cell, per cell group, per bearer, or per HARQ process.

For example, that the granularity of the network signaling is per terminal equipment includes that the network signaling and/or an indication included in the network signaling is/are applicable to the terminal equipment.

For example, that the granularity of the network signaling is per cell includes that the network signaling and/or an indication included in the network signaling is/are applicable to the cell.

For example, that the granularity of the network signaling is per cell group includes that the network signaling and/or an indication included in the network signaling is/are applicable to the cell group.

For example, that the granularity of the network signaling is per bearer includes that the network signaling and/or an indication included in the network signaling is applicable to the bearer.

For example, that the granularity of the network signaling is per HARQ procedure includes that the network signaling and/or an indication included in the network signaling is/are applicable to the HARQ process.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 5

The embodiment of this disclosure provides an apparatus for cell switching, applicable to a first network node. As a principle of the apparatus for solving problems is similar to that of the method in embodiment 2, reference may be made to the implementation of the method described in embodiment 2 for implementation of the apparatus, with identical or related contents being not going to be described herein any further.

FIG. 8 is a schematic diagram of the apparatus for apparatus for cell switching of embodiment 5 of this disclosure. As shown in FIG. 8, an apparatus 800 includes:
a first transmitting unit 801 configured to transmit L1 signaling and/or L2 signaling to a terminal equipment to indicate the terminal equipment to switch a serving cell to a cell indicated by the L2 signaling and/or the L1 signaling,
wherein the switching a serving cell to a cell indicated by the L2 signaling and/or the L1 signaling comprises at least one of partial MAC entity resetting, partial RLC reestablishment, partial PDCP reestablishment or processing a timer maintained by an RRC layer.

In the embodiments of this disclosure, as shown in FIG. 8, the apparatus further includes:
a second transmitting unit 802 configured to transmit network signaling to the terminal equipment, the network signaling indicating the terminal equipment to perform at least one of partial MAC entity resetting, partial RLC reestablishment or partial PDCP reestablishment when the cell is changed.

In the embodiments of this disclosure, the network signaling includes at least one of the following:
an indication for ROCH resetting,
an indication for EHC resetting,
an indication for stopping UDC discarding,
an indication for updating an encryption algorithm and key; or
an indication for updating an integrity algorithm and key.

In the embodiments of this disclosure, the indication for ROCH resetting is used to indicate resetting of uplink ROCH and/or downlink ROCH.

In the embodiments of this disclosure, the indication for ROCH resetting includes an indication indicating resetting of uplink ROCH and downlink ROCH, or,
the indication for resetting of ROCH includes a first indication and a second indication, the first indication indicating resetting of the uplink ROCH, and the second indication indicating resetting of the downlink ROCH.

In the embodiments of this disclosure, the indication for EHC resetting is used to indicate resetting of an uplink EHC protocol.

In the embodiments of this disclosure, the network signaling includes at least one of an RRC message, an MAC CE, and DCI.

In the embodiments of this disclosure, a granularity of the network signaling is: per terminal equipment, per cell, per cell group, per bearer, or per HARQ process.

In the embodiments of this disclosure, that the granularity of the network signaling is per terminal equipment includes that the network signaling and/or an indication included in the network signaling is/are applicable to the terminal equipment.

In the embodiments of this disclosure, that the granularity of the network signaling is per cell includes that the network signaling and/or an indication included in the network signaling is/are applicable to the cell.

In the embodiments of this disclosure, that the granularity of the network signaling is per cell group includes that the network signaling and/or an indication included in the network signaling is/are applicable to the cell group.

In the embodiments of this disclosure, that the granularity of the network signaling is per bearer includes that the network signaling and/or an indication included in the network signaling is applicable to the bearer.

In the embodiments of this disclosure, that the granularity of the network signaling is per HARQ procedure includes that the network signaling and/or an indication included in the network signaling is/are applicable to the HARQ process.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 6

The embodiment of this disclosure provides a terminal equipment, including the apparatus for cell switching as described in embodiment 4.

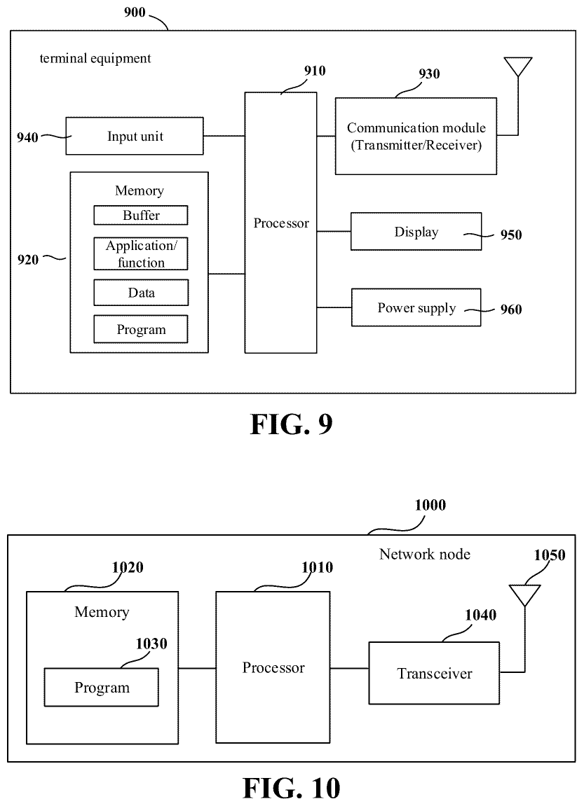

FIG. 9 is a block diagram of a systematic structure of the terminal equipment of embodiment 6 of this disclosure. As shown in FIG. 9, a terminal equipment 900 may include a processor 910 and a memory 920, the memory 920 storing data and a program and being coupled to the processor 910. It should be noted that this figure is illustrative only, and other types of structures may also be used, so as to supplement or replace this structure and achieve a telecommunications function or other functions.

In one implementation, the functions of the apparatus for cell switching may be integrated into the processor 910.

In the embodiments of this disclosure, the processor 910 may be configured to: receive L1 signaling and/or L2 signaling from a first network node; and switch a serving cell to a cell indicated by the L2 signaling and/or the L1 signaling, wherein the switching a serving cell to a cell indicated by the L2 signaling and/or the L1 signaling comprises at least one of L1 partial resetting, L2 partial resetting, or processing a timer maintained by an RRC layer.

In another implementation, the apparatus for cell switching and the processor 910 may be configured separately; for example, the apparatus for cell switching may be configured as a chip connected to the processor 910, and the functions of the apparatus for cell switching are executed under control of the processor 910.

As shown in FIG. 9, the terminal equipment 900 may further include a communication module 930, an input unit 940, a display 950, and a power supply 960. It should be noted that the terminal equipment 900 does not necessarily include all the parts shown in FIG. 9, and the above components are not necessary. Furthermore, the terminal equipment 900 may include parts not shown in FIG. 9, and the related art may be referred to.

As shown in FIG. 9, the processor 910 is sometimes referred to as a controller or an operational control, which may include a microprocessor or other processor devices and/or logic devices. The processor 910 receives input and controls operations of components of the terminal equipment 900.

Wherein, the memory 920 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 910 may execute programs stored in the memory 920, so as to realize information storage or processing, etc. Functions of other parts are similar to those of the related art, which shall not be described herein any further. The parts of the terminal equipment 900 may be realized by specific hardware, firmware, software, or any combination thereof, without departing from the scope of this disclosure.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 7

The embodiment of this disclosure provides a network node, including the apparatus for cell switching as described in embodiment 5.

FIG. 10 is a block diagram of a systematic structure of the network node of embodiment 7 of this disclosure. As shown in FIG. 10, a network node 1000 may include a processor 1010 and a memory 1020, the memory 1020 being coupled to the processor 1010. Wherein, the memory 1020 may store various data, and furthermore, it may store a program 1030 for information processing, and execute the program 1030 under control of the processor 1010, so as to receive various information transmitted by a terminal equipment, and transmit various information to the terminal equipment.

In one implementation, the functions of the apparatus for cell switching may be integrated into the processor 1010.

In the embodiments of this disclosure, the processor 1010 may be configured to: transmit L1 signaling and/or L2 signaling to a terminal equipment to indicate the terminal equipment to switch a serving cell to a cell indicated by the L2 signaling and/or the L1 signaling, wherein the switching a serving cell to a cell indicated by the L2 signaling and/or the L1 signaling comprises at least one of partial MAC entity resetting, partial RLC reestablishment, partial PDCP reestablishment or processing a timer maintained by an RRC layer.

In another implementation, the apparatus for cell switching and the processor 1010 may be configured separately; for example, the apparatus for cell switching may be configured as a chip connected to the processor 1010, and the functions of the apparatus for cell switching are executed under control of the processor 1010.

Furthermore, as shown in FIG. 10, the network node 1000 may include a transceiver 1040, and an antenna 1050, etc. Wherein, functions of the above components are similar to those in the related art, and shall not be described herein any further. It should be noted that the network node 1000 does not necessarily include all the parts shown in FIG. 10, and furthermore, the network node 1000 may include parts not shown in FIG. 10, and the related art may be referred to.

It can be seen from the above embodiment that the terminal equipment switches the serving cell to a cell indicated by the L2 signaling and/or the L1 signaling according to the received L1 signaling and/or the received L2 signaling from a source network node, wherein the change includes at least one of L1 partial resetting, L2 partial resetting, or processing a timer maintained by an RRC layer, thereby providing an effective mechanism realizing a procedure of L1/L2 based cell switch, and lowing latency, signaling overhead and interruption times.

### Embodiment 8

The embodiment of this disclosure provides a communication system, including the terminal equipment described in embodiment 6 and/or the network node described in embodiment 7, and reference may be made to the disclosure contained in embodiment 6 and embodiment 7 for details.

For example, reference may be made to FIG. 1 for a structure of the communication system. As shown in FIG. 1, the communication system 100 includes the first network node 101 and the terminal equipment 102. The terminal equipment 102 may be identical to the terminal equipment described in embodiment 6, and/or, the first network node 101 may be identical to the first network node described in embodiment 7, with repeated parts being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 8 may either correspond to software modules of procedures of a computer program, or correspond to hardware modules. Such software modules may respectively correspond to the steps shown in FIG. 5. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 8 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 8 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

### Supplement I

1. An apparatus for cell switching, applicable to a terminal equipment, the apparatus including:
a first receiving unit configured to receive L1 signaling and/or L2 signaling from a first network node; and
a first switch unit configured to switch a serving cell to a cell indicated by the L2 signaling and/or the L1 signaling,
wherein the switching a serving cell to a cell indicated by the L2 signaling and/or the L1 signaling comprises at least one of L1 partial resetting, L2 partial resetting, or processing a timer maintained by an RRC layer.

2. The apparatus according to supplement 1, wherein the L2 partial resetting includes:
at least one of partial MAC entity resetting, partial RLC reestablishment, and partial PDCP reestablishment.

3. The apparatus according to supplement 1 or 2, wherein,
the processing a timer maintained by an RRC layer includes: starting or restarting the timer maintained by the RRC layer, and/or stopping the timer maintained by the RRC layer.

4. The apparatus according to supplement 3, wherein,
the starting or restarting the timer maintained by the RRC layer includes: starting or restarting a handover timer.

5. The apparatus according to supplement 3, wherein,
the stopping the timer maintained by the RRC layer includes at least one of the following actions:
stopping a timer related to radio link monitoring;
stopping a timer related to failure reporting; or
stopping a timer related to an access attempt.

6. The apparatus according to supplement 2, wherein the partial MAC entity resetting includes at least one of the following actions:
for a first timer, applying a value of the first timer or restarting the first timer;
not considering that a TA-related timer expires;
not cancelling a triggered BSR procedure; or
not clearing a soft buffer of a downlink HARQ process.

7. The apparatus according to supplement 6, wherein the apparatus further includes:
a second receiving unit configured to receive configuration information of a group of cells from the first network node,
and when the configuration information includes a value of the first timer, the value is applied; and/or,
when the configuration information does not include a value of the first timer, the first timer is restarted.

8. The apparatus according to supplement 7, wherein the restarting the first timer includes:
restarting the first timer and using a previous value.

9. The apparatus according to any one of supplements 6-8, wherein,
the first timer is a timer maintained by an MAC layer.

10. The apparatus according to supplement 2, wherein the partial RLC reestablishment includes at least one of the following actions:
not discarding RLC SDUs, RLC SDU segments and RLC PDUs; or
for a second timer, applying a value of the second timer or restarting the second timer.

11. The apparatus according to supplement 10, wherein the apparatus further includes:
a third receiving unit configured to receive configuration information of a group of cells from the first network node,
and when the configuration information includes a value of the second timer, the value is applied; and/or,
when the configuration information does not include a value of the second timer, the second timer is restarted.

12. The apparatus according to supplement 11, wherein the restarting the second timer includes:
restarting the second timer and using a previous value.

13. The apparatus according to any one of supplements 10-12, wherein,
the second timer is a timer maintained by an RLC layer.

14. The apparatus according to supplement 2, wherein the partial PDCP reestablishment includes at least one of the following actions:
reestablishing a PDCP without key updating; or
not performing data recovery.

15. The apparatus according to supplement 14, wherein the reestablishing a PDCP without key updating includes:
continuing to apply same encryption algorithm and key as a source cell by a transmitting PDCP entity, and/or continuing to apply same integrity algorithm and key as the source cell by the transmitting PDCP entity.

16. The apparatus according to supplement 15, wherein the reestablishing a PDCP without key updating further includes:
that the transmitting PDCP entity will execute at least one of the following:
for UM DRB and/or AM DRB, continuing a current ROCH;
for UM DRB and/or AM DRB, continuing with a current EHC; and
for AM DRB, continuing to discard UDC.

17. The apparatus according to supplement 14 or 15, wherein the reestablishing a PDCP without key updating includes:
continuing to apply same encryption algorithm and key as a source cell by a receiving PDCP entity, and/or continuing to apply same integrity algorithm and key as the source cell by the receiving PDCP entity.

18. The apparatus according to supplement 17, wherein the reestablishing a PDCP without key updating further includes:
for UM DRB and/or AM DRB, continuing with a current ROCH by the receiving PDCP entity.

19. The apparatus according to supplement 1, wherein the apparatus further includes:
a fourth receiving unit configured to receive network signaling from the first network node; and
a determining unit configured to determine to perform at least one of partial MAC entity resetting, partial RLC reestablishment or partial PDCP reestablishment according to the network signaling when the cell is changed.

20. The apparatus according to supplement 19, wherein,
when the network command includes an indication for ROCH reset, the terminal equipment resets the ROCH protocol.

21. The apparatus according to supplement 19, wherein,
when the network command does not include an indication for ROCH reset, the terminal equipment does not reset the ROCH protocol or continues with the current ROCH.

22. The apparatus according to supplement 19, wherein,
when the network command includes a first indication for ROCH reset, the transmitting PDCP entity of the terminal equipment resets an uplink ROCH protocol.

23. The apparatus according to supplement 19, wherein,
when the network command does not include the first indication for ROCH reset, the transmitting PDCP entity of the terminal equipment does not reset the uplink ROCH protocol or continues with the current uplink ROCH.

24. The apparatus according to supplement 19 or 22 or 23, wherein,
when the network command includes a second indication for ROCH reset, the receiving PDCP entity of the terminal equipment resets the downlink ROCH protocol.

25. The apparatus according to supplement 19 or 22 or 23, wherein,
when the network command does not include a second indication for ROCH reset, the receiving PDCP entity of the terminal equipment does not reset the downlink ROCH protocol or continues with the current downlink ROCH.

26. The apparatus according to supplement 19, wherein,
when the network command includes a third indication for EHC reset, the transmitting PDCP entity of the terminal equipment resets the uplink EHC protocol.

27. The apparatus according to supplement 19, wherein,
when the network command does not include a third indication for EHC reset, the transmitting PDCP entity of the terminal equipment does not reset the uplink EHC protocol or continues with the current uplink EHC.

28. The apparatus according to supplement 19, wherein,
when the network command includes a fourth indication for stopping UDC discarding, the transmitting PDCP of the terminal equipment does not continue to discard UDC.

29. The apparatus according to supplement 19, wherein,
when the network command does not include a fourth indication for stopping UDC discarding, the transmitting PDCP entity of the terminal equipment continues to discard UDC.

30. The apparatus according to supplement 19, wherein,
when the network command includes a fifth indication for updating an encryption algorithm and key, the transmitting PDCP and/or receiving PDCP of the terminal equipment update(s) the encryption algorithm and key.

31. The apparatus according to supplement 19, wherein,
when the network command does not include a fifth indication for updating an encryption algorithm and key, the transmitting PDCP and/or receiving PDCP of the terminal equipment continues to apply an encryption algorithm and key identical to that of the source cell.

32. The apparatus according to supplement 19, wherein,
when the network command includes a sixth indication for updating an integrity algorithm and key, the transmitting PDCP and/or receiving PDCP of the terminal equipment update(s) an integrity algorithm and key.

33. The apparatus according to supplement 19, wherein,
when the network command does not include the sixth indication for updating the integrity algorithm and key, the transmitting PDCP and/or receiving PDCP of the terminal equipment continues to apply an integrity algorithm and key identical to that of the source cell.

34. The apparatus according to any one of supplements 19-33, wherein,
the network signaling includes at least one of an RRC message, an MAC CE, and DCI.

35. The apparatus according to any one of supplements 19-34, wherein,
a granularity of the network signaling is: per terminal equipment, per cell, per cell group, per bearer, or per HARQ process.

36. The apparatus according to supplement 35, wherein that the granularity of the network signaling is per terminal equipment includes that the network signaling and/or an indication included in the network signaling is/are applicable to the terminal equipment.

37. The apparatus according to supplement 35, wherein that the granularity of the network signaling is per cell includes:
that the network signaling and/or an indication included in the network signaling is/are applicable to the cell.

38. The apparatus according to supplement 35, wherein that the granularity of the network signaling is per cell group includes:
that the network signaling and/or an indication included in the network signaling is/are applicable to the cell group.

39. The apparatus according to supplement 35, wherein that the granularity of the network signaling is per bearer includes:
that the network signaling and/or an indication included in the network signaling is applicable to the bearer.

40. The apparatus according to supplement 35, wherein that the granularity of the network signaling is per HARQ procedure includes:
that the network signaling and/or an indication included in the network signaling is/are applicable to the HARQ process.

41. An apparatus for cell switching, applicable to a first network node, the apparatus including:
a first transmitting unit configured to transmit L1 signaling and/or L2 signaling to a terminal equipment to indicate the terminal equipment to switch a serving cell to a cell indicated by the L2 signaling and/or the L1 signaling,
wherein the switching a serving cell to a cell indicated by the L2 signaling and/or the L1 signaling comprises at least one of partial MAC entity resetting, partial RLC reestablishment, partial PDCP reestablishment or processing a timer maintained by an RRC layer.

42. The apparatus according to supplement 41, wherein the apparatus further includes:
a second transmitting unit configured to transmit network signaling to the terminal equipment, the network signaling indicating the terminal equipment to perform at least one of partial MAC entity resetting, partial RLC reestablishment or partial PDCP reestablishment when the cell is changed.

43. The apparatus according to supplement 42, wherein the network signaling includes at least one of the following:
an indication for ROCH resetting,
an indication for EHC resetting,
an indication for stopping UDC discarding,
an indication for updating an encryption algorithm and key; or
an indication for updating an integrity algorithm and key.

44. The apparatus according to supplement 43, wherein,
the indication for ROCH resetting is used to indicate resetting of uplink ROCH and/or downlink ROCH.

45. The apparatus according to supplement 43, wherein,
the indication for ROCH resetting includes an indication,
the indication indicating resetting of uplink ROCH and downlink ROCH, or,
the indication for resetting of ROCH includes a first indication and a second indication,
the first indication indicating resetting of the uplink ROCH,
and the second indication indicating resetting of the downlink ROCH.

46. The apparatus according to supplement 43, wherein,
the indication for EHC resetting is used to indicate resetting of an uplink EHC protocol.

47. The apparatus according to any one of supplements 42-46, wherein,
the network signaling includes at least one of an RRC message, an MAC CE, and DCI.

48. The apparatus according to any one of supplements 42-47, wherein,
a granularity of the network signaling is: per terminal equipment, per cell, per cell group, per bearer, or per HARQ process.

49. The apparatus according to supplement 48, wherein that the granularity of the network signaling is per terminal equipment includes:
that the network signaling and/or an indication included in the network signaling is/are applicable to the terminal equipment.

50. The apparatus according to supplement 48, wherein that the granularity of the network signaling is per cell includes:
that the network signaling and/or an indication included in the network signaling is/are applicable to the cell.

51. The apparatus according to supplement 48, wherein that the granularity of the network signaling is per cell group includes:
that the network signaling and/or an indication included in the network signaling is/are applicable to the cell group.

52. The apparatus according to supplement 48, wherein that the granularity of the network signaling is per bearer includes:
that the network signaling and/or an indication included in the network signaling is applicable to the bearer.

53. The apparatus according to supplement 48, wherein that the granularity of the network signaling is per HARQ procedure includes:
that the network signaling and/or an indication included in the network signaling is/are applicable to the HARQ process.

54. A terminal equipment, including the apparatus as described in any of supplements 1-40.

55. A network node, including the apparatus as described in any one of supplements 41-53.

56. A communication system, including the terminal equipment as described in supplement 54 and/or the network node as described in supplement 55.

### Supplement II

1. A method for cell switching, applicable to a terminal equipment, the method including:
receiving L1 signaling and/or L2 signaling from a first network node; and
switching a serving cell to a cell indicated by the L2 signaling and/or the L1 signaling,
wherein the switching a serving cell to a cell indicated by the L2 signaling and/or the L1 signaling comprises at least one of L1 partial resetting, L2 partial resetting, or processing a timer maintained by an RRC layer.

2. The method according to supplement 1, wherein the L2 partial resetting includes:
at least one of partial MAC entity resetting, partial RLC reestablishment, and partial PDCP reestablishment.

3. The method according to supplement 1 or 2, wherein,
the processing a timer maintained by an RRC layer includes: starting or restarting the timer maintained by the RRC layer, and/or stopping the timer maintained by the RRC layer.

4. The method according to supplement 3, wherein,
the starting or restarting the timer maintained by the RRC layer includes: starting or restarting a handover timer.

5. The method according to supplement 3, wherein,
the stopping the timer maintained by the RRC layer includes at least one of the following actions:
stopping a timer related to radio link monitoring;
stopping a timer related to failure reporting; and
stopping a timer related to an access attempt.

6. The method according to supplement 2, wherein the partial MAC entity resetting includes at least one of the following actions:
for a first timer, applying a value of the first timer or restarting the first timer;
not considering that a TA-related timer expires;
not cancelling a triggered BSR procedure; or
not clearing a soft buffer of a downlink HARQ process.

7. The method according to supplement 6, wherein the method further includes:
receiving configuration information of a group of cells from the first network node,
and when the configuration information includes a value of the first timer, the value is applied; and/or,
when the configuration information does not include a value of the first timer, the first timer is restarted.

8. The method according to supplement 7, wherein the restarting the first timer includes:
restarting the first timer and using a previous value.

9. The method according to any one of supplements 6-8, wherein,
the first timer is a timer maintained by an MAC layer.

10. The method according to supplement 2, wherein the partial RLC reestablishment includes at least one of the following actions:
not discarding RLC SDUs, RLC SDU segments and RLC PDUs; and
for a second timer, applying a value of the second timer or restarting the second timer.

11. The method according to supplement 10, wherein the method further includes:
receiving configuration information of a group of cells from the first network node,
and when the configuration information includes a value of the second timer, the value is applied; and/or,
when the configuration information does not include a value of the second timer, the second timer is restarted.

12. The method according to supplement 11, wherein the restarting the second timer includes:
restarting the second timer and using a previous value.

13. The method according to any one of supplements 10-12, wherein,
the second timer is a timer maintained by an RLC layer.

14. The method according to supplement 2, wherein the partial PDCP reestablishment includes at least one of the following actions:
reestablishing a PDCP without key updating; and
not performing data recovery.

15. The method according to supplement 14, wherein the reestablishing a PDCP without key updating includes:
continuing to apply same encryption algorithm and key as a source cell by a transmitting PDCP entity, and/or continuing to apply same integrity algorithm and key as the source cell by the transmitting PDCP entity.

16. The method according to supplement 15, wherein the reestablishing a PDCP without key updating further includes:
that the transmitting PDCP entity will execute at least one of the following:
for UM DRB and/or AM DRB, continuing a current ROCH;
for UM DRB and/or AM DRB, continuing with a current EHC; and
for AM DRB, continuing to discard UDC.

17. The method according to supplement 14 or 15, wherein the reestablishing a PDCP without key updating includes:
continuing to apply same encryption algorithm and key as a source cell by a receiving PDCP entity, and/or continuing to apply same integrity algorithm and key as the source cell by the receiving PDCP entity.

18. The method according to supplement 17, wherein the reestablishing a PDCP without key updating further includes:
for UM DRB and/or AM DRB, continuing with a current ROCH by the receiving PDCP entity.

19. The method according to supplement 1, wherein the method further includes:
receiving network signaling from the first network node; and
determining to perform at least one of partial MAC entity resetting, partial RLC reestablishment or partial PDCP reestablishment according to the network signaling when the cell is changed.

20. The method according to supplement 19, wherein,
when the network command includes an indication for ROCH reset, the terminal equipment resets the ROCH protocol.

21. The method according to supplement 19, wherein,
when the network command does not include an indication for ROCH reset, the terminal equipment does not reset the ROCH protocol or continues with the current ROCH.

22. The method according to supplement 19, wherein,
when the network command includes a first indication for ROCH reset, the transmitting PDCP entity of the terminal equipment resets an uplink ROCH protocol.

23. The method according to supplement 19, wherein,
when the network command does not include the first indication for ROCH reset, the transmitting PDCP entity of the terminal equipment does not reset the uplink ROCH protocol or continues with the current uplink ROCH.

24. The method according to supplement 19 or 22 or 23, wherein,
when the network command includes a second indication for ROCH reset, the receiving PDCP entity of the terminal equipment resets the downlink ROCH protocol.

25. The method according to supplement 19 or 22 or 23, wherein,
when the network command does not include a second indication for ROCH reset, the receiving PDCP entity of the terminal equipment does not reset the downlink ROCH protocol or continues with the current downlink ROCH.

26. The method according to supplement 19, wherein,
when the network command includes a third indication for EHC reset, the transmitting PDCP entity of the terminal equipment resets the uplink EHC protocol.

27. The method according to supplement 19, wherein,
when the network command does not include a third indication for EHC reset, the transmitting PDCP entity of the terminal equipment does not reset the uplink EHC protocol or continues with the current uplink EHC.

28. The method according to supplement 19, wherein,
when the network command includes a fourth indication for stopping UDC discarding, the transmitting PDCP of the terminal equipment does not continue to discard UDC.

29. The method according to supplement 19, wherein,
when the network command does not include a fourth indication for stopping UDC discarding, the transmitting PDCP entity of the terminal equipment continues to discard UDC.

30. The method according to supplement 19, wherein,
when the network command includes a fifth indication for updating an encryption algorithm and key, the transmitting PDCP and/or receiving PDCP of the terminal equipment update(s) the encryption algorithm and key.

31. The method according to supplement 19, wherein,
when the network command does not include a fifth indication for updating an encryption algorithm and key, the transmitting PDCP and/or receiving PDCP of the terminal equipment continues to apply an encryption algorithm and key identical to that of the source cell.

32. The method according to supplement 19, wherein,
when the network command includes a sixth indication for updating an integrity algorithm and key, the transmitting PDCP and/or receiving PDCP of the terminal equipment update(s) an integrity algorithm and key.

33. The method according to supplement 19, wherein,
when the network command does not include the sixth indication for updating the integrity algorithm and key, the transmitting PDCP and/or receiving PDCP of the terminal equipment continues to apply an integrity algorithm and key identical to that of the source cell.

34. The method according to any one of supplements 19-33, wherein,
the network signaling includes at least one of an RRC message, an MAC CE, and DCI.

35. The method according to any one of supplements 19-34, wherein,
a granularity of the network signaling is: per terminal equipment, per cell, per cell group, per bearer, or per HARQ process.

36. The method according to supplement 35, wherein that the granularity of the network signaling is per terminal equipment includes that the network signaling and/or an indication included in the network signaling is/are applicable to the terminal equipment.

37. The method according to supplement 35, wherein that the granularity of the network signaling is per cell includes:
that the network signaling and/or an indication included in the network signaling is/are applicable to the cell.

38. The method according to supplement 35, wherein that the granularity of the network signaling is per cell group includes:
that the network signaling and/or an indication included in the network signaling is/are applicable to the cell group.

39. The method according to supplement 35, wherein that the granularity of the network signaling is per bearer includes:
that the network signaling and/or an indication included in the network signaling is applicable to the bearer.

40. The method according to supplement 35, wherein that the granularity of the network signaling is per HARQ procedure includes:
that the network signaling and/or an indication included in the network signaling is/are applicable to the HARQ process.

41. A method for cell switching, applicable to a first network node, the method including:
transmitting L1 signaling and/or L2 signaling to a terminal equipment to indicate the terminal equipment to switch a serving cell to a cell indicated by the L2 signaling and/or the L1 signaling,
wherein the switching a serving cell to a cell indicated by the L2 signaling and/or the L1 signaling comprises at least one of partial MAC entity resetting, partial RLC reestablishment, partial PDCP reestablishment or processing a timer maintained by an RRC layer.

42. The method according to supplement 41, wherein the method further includes:
transmitting network signaling to the terminal equipment, the network signaling indicating the terminal equipment to perform at least one of partial MAC entity resetting, partial RLC reestablishment or partial PDCP reestablishment when the cell is changed.

43. The method according to supplement 42, wherein the network signaling includes at least one of the following:
an indication for ROCH resetting,
an indication for EHC resetting,
an indication for stopping UDC discarding,
an indication for updating an encryption algorithm and key; or
an indication for updating an integrity algorithm and key.

44. The method according to supplement 43, wherein,
the indication for ROCH resetting is used to indicate resetting of uplink ROCH and/or downlink ROCH.

45. The method according to supplement 43, wherein,
the indication for ROCH resetting includes an indication,
the indication indicating resetting of uplink ROCH and downlink ROCH, or,
the indication for resetting of ROCH includes a first indication and a second indication,
the first indication indicating resetting of the uplink ROCH,
and the second indication indicating resetting of the downlink ROCH.

46. The method according to supplement 43, wherein,
the indication for EHC resetting is used to indicate resetting of an uplink EHC protocol.

47. The method according to any one of supplements 42-46, wherein,
the network signaling includes at least one of an RRC message, an MAC CE, and DCI.

48. The method according to any one of supplements 42-47, wherein,
a granularity of the network signaling is: per terminal equipment, per cell, per cell group, per bearer, or per HARQ process.

49. The method according to supplement 48, wherein that the granularity of the network signaling is per terminal equipment includes:
that the network signaling and/or an indication included in the network signaling is/are applicable to the terminal equipment.

50. The method according to supplement 48, wherein that the granularity of the network signaling is per cell includes:
that the network signaling and/or an indication included in the network signaling is/are applicable to the cell.

51. The method according to supplement 48, wherein that the granularity of the network signaling is per cell group includes:
that the network signaling and/or an indication included in the network signaling is/are applicable to the cell group.

52. The method according to supplement 48, wherein that the granularity of the network signaling is per bearer includes:
that the network signaling and/or an indication included in the network signaling is applicable to the bearer.

53. The method according to supplement 48, wherein that the granularity of the network signaling is per HARQ procedure includes:
that the network signaling and/or an indication included in the network signaling is/are applicable to the HARQ process.

What is claimed is:

1. An apparatus for cell switching, applicable to a terminal equipment, the apparatus comprising:
a first receiver configured to receive a MAC CE (Control Element) from a first network node; and
a processor circuitry configured to switch a serving cell to a cell indicated by the MAC CE,
wherein the switching a serving cell to a cell indicated by the MAC CE comprises at least one of a L1 reset procedure, a L2 reset procedure, or processing a timer maintained by an RRC (Radio Resource Control) layer.

2. The apparatus according to claim 1, wherein the L2 reset procedure comprises:
at least one of a MAC entity reset procedure, a RLC (Radio Link Control) reestablishment procedure, and a PDCP (Packet Data Convergence Protocol) reestablishment procedure.

3. The apparatus according to claim 1, wherein,
the processing a timer maintained by an RRC layer comprises: starting or restarting the timer maintained by the RRC layer, and/or stopping the timer maintained by the RRC layer.

4. The apparatus according to claim 3, wherein,
the starting or restarting the timer maintained by the RRC layer comprises: starting or restarting a handover timer.

5. The apparatus according to claim 3, wherein,
the stopping the timer maintained by the RRC layer comprises at least one of the following actions:
stopping a timer related to radio link monitoring;
stopping a timer related to failure reporting; or
stopping a timer related to an access attempt.

6. The apparatus according to claim 2, wherein the MAC entity reset procedure comprises at least one of the following actions:
for a first timer, applying a value of the first timer or restarting the first timer;
not considering that a TA (Timing Advance)-related timer expires;
not cancelling a triggered BSR (Buffer Status Report) procedure; or
not clearing a soft buffer of a downlink HARQ (Hybrid Automatic Repeat reQuest) procedure.

7. The apparatus according to claim 6, wherein the apparatus further comprises:
a second receiver configured to receive configuration information of a group of cells from the first network node,
and when the configuration information comprises a value of the first timer, the value is applied; and/or,
when the configuration information does not comprise a value of the first timer, the first timer is restarted.

8. The apparatus according to claim 6, wherein,
the first timer is a timer maintained by an MAC layer.

9. The apparatus according to claim 2, wherein the RLC reestablishment procedure comprises at least one of the following actions:
not discarding RLC SDUs (Service Data Unit), RLC SDU segments and RLC PDUs (Protocol Data Unit); or
for a second timer, applying a value of the second timer or restarting the second timer.

10. The apparatus according to claim 9, wherein the apparatus further comprises:
a third receiver configured to receive configuration information of a group of cells from the first network node,
and when the configuration information comprises a value of the second timer, the value is applied; and/or,
when the configuration information does not comprise a value of the second timer, the second timer is restarted.

11. The apparatus according to claim 9, wherein,
the second timer is a timer maintained by an RLC layer.

12. The apparatus according to claim 2, wherein the PDCP reestablishment procedure comprises at least one of the following actions:
reestablishing a PDCP without key updating; or
not performing data recovery.

13. The apparatus according to claim 12, wherein the reestablishing a PDCP without key updating comprises:
continuing to apply same encryption algorithm and key as a source cell by a transmitting PDCP entity, and/or continuing to apply same integrity algorithm and key as the source cell by the transmitting PDCP entity.

14. The apparatus according to claim 12, wherein the reestablishing a PDCP without key updating comprises:
continuing to apply same encryption algorithm and key as a source cell by a receiving PDCP entity, and/or continuing to apply same integrity algorithm and key as the source cell by the receiving PDCP entity.

15. The apparatus according to claim 1, wherein the apparatus further comprises:
a fourth receiver configured to receive network signaling from the first network node; and
the processor circuitry further configured to determine to perform at least one of a MAC entity reset procedure, a RLC reestablishment procedure or a PDCP reestablishment procedure according to the network signaling when the cell is switched.

16. An apparatus for cell switching, applicable to a first network node, the apparatus comprising:
a first transmitter configured to transmit A MAC CE (Control Element) to a terminal equipment to indicate the terminal equipment to switch a serving cell to a cell indicated by the MAC CE,
wherein the switching a serving cell to a cell indicated by the MAC CE comprises at least one of a first MAC entity reset procedure, a first RLC (Radio Link Control) reestablishment procedure, a first PDCP (Packet Data Convergence Protocol) reestablishment procedure or processing a timer maintained by an RRC (Radio Resource Control) layer.

17. The apparatus according to claim 16, wherein the apparatus further comprises:
a second transmitter configured to transmit network signaling to the terminal equipment, the network signaling indicating the terminal equipment to perform at least one of a second MAC entity reset procedure, a second RLC reestablishment procedure or a second PDCP reestablishment procedure when the cell is switched.

18. The apparatus according to claim 17, wherein the network signaling comprises at least one of the following:
an indication for ROCH resetting,
an indication for EHC (Ethernet Header Compression) resetting,
an indication for stopping UDC (Uplink Data Compression) dropping,
an indication for updating an encryption algorithm and key; or
an indication for updating an integrity algorithm and key.

19. The apparatus according to claim 17, wherein,
a granularity of the network signaling is: per terminal equipment, per cell, per cell group, per carrier or per HARQ (Hybrid Automatic Repeat reQuest) procedure.

20. A communication system, comprising a terminal equipment and/or a network node, the terminal equipment comprising:
an apparatus for cell switching, applicable to a terminal equipment, the apparatus comprising:
a first receiver configured to receive a MAC CE (Control Element) from a first network node; and
a processor circuitry configured to switch a serving cell to a cell indicated by the MAC CE,
wherein the switching a serving cell to a cell indicated by the MAC CE comprises at least one of a L1 reset procedure, a L2 reset procedure, or processing a timer maintained by an RRC (Radio Resource Control) layer, and
the network node comprising the apparatus as claimed in claim 16.
